(19) United States
(12) Patent Application Publication
(10) Pub. No.: US 2011/0277249 A1
(43) Pub. Date: Nov. 17, 2011

(54) Method of Producing Colored High-Strength Fibers

(76) Inventors: Ferass Abuzaina, Shelton, CT (US); Ali Irfan, Shelton, CT (US)

(21) Appl. No.: 12/780,181

(22) Filed: May 14, 2010

(51) Int. Cl. C09B 67/00

(52) U.S. Cl. 8/495; 8/576; 8/582; 8/587; 8/598; 8/603; 8/609; 8/611; 8/614; 8/617; 8/636

(57) ABSTRACT

Colored high-strength fibers of ultra-high-molecular-weight polyolefins and methods of dyeing the high-strength fibers are disclosed herein.

### BACKGROUND

1. Technical Field

The present disclosure relates to methods for producing colored high-strength fibers, and more particularly, to methods for producing colored high-strength fibers of ultra-high-molecular-weight polyolefins.

2. Background of Related Art

Surgeons are constantly seeking stronger fiber materials suitable for withstanding increase stress following implantation. This is true in the fields of arthroscopy and laparoscopy, as well as in the field of open procedures.

Recently, there has been developed ultra-high-molecular-weight polyolefins which may be formed into high-strength, high-modulus fibers. With this development, there have been proposed various processes for producing high-strength and high-modulus fibers from it. Moreover, the high-strength fibers have been incorporated into many multifilament devices. However, difficulty with identifying the high-strength fibers during a surgical procedure has required the addition of easily colored non-high-strength fibers which may be considerably weaker. Because these non-high-strength fibers may be combined into the multifilament devices, the multifilament devices may be less strong and more susceptible to a break.

Polyolefins, and particularly ultra-high-molecular-weight polyolefins, may be hydrophobic and difficult to dye with disperse dyes since they lack dye sites to which dye molecules may become attached. Van der Waals forces and hydrogen bonds may be given as the reason for the dyes to have affinity for given polymers. Also, polyolefins may not be dyeable by acid dyes since they lack basic sites with which the dye may form a salt bond. Those skilled in the art of manufacturing polyolefin fibers may have recognized that the inability to successfully dye polyolefins has limited its growth, particularly to uses where high-strength fibers may be required, such as meniscal repair, or other laparoscopic or arthroscopic procedures.

### SUMMARY

The present disclosure describes a process for producing colored high-strength fibers. The colored high-strength fibers may be produced, while maintaining sufficiently high tensile strength and high tensile modulus, from ultra-high-molecular-weight polyolefins by contacting at least a portion of the high-strength fiber with at least one etching agent, followed by the application of at least one dye to the high-strength fiber. In embodiments, the etched high-strength fiber may be rinsed with a rinsing agent and dried prior to the application of the dye. In embodiments, the dye may be applied in a liquid form.

Also provided is a process for producing a colored high-strength fiber of ultra-high-molecular-weight polyethylene, comprising the steps of: contacting at least a portion of a ultra-high-molecular-weight polyethylene fiber with an etching agent; rinsing the etched fiber with deionized water; drying the rinsed ultra-high-molecular weight polyethylene fiber; and applying at least one dye to the dried fiber to form a colored high-strength fiber of ultra-high-molecular-weight polyethylene. In some embodiments, the etching agent may be sodium hydroxide. In some embodiments, the at least one dye may be a biocompatible blue pigment such as Chromium-Cobalt-Aluminum Oxide.

### DETAILED DESCRIPTION

The present disclosure describes colored high-strength fibers. As used herein “high-strength” refers to fibers which display sufficiently high tensile strength and high tensile modulus. For example, a size 2/0 high-strength fiber may display a tensile strength of at least 190N.

The high-strength fibers may be formed using any suitable biocompatible material. In some embodiments, the high-strength fibers may be formed from at least one polyolefin, such as polyethylene or polypropylene. In certain embodiments, the high-strength fiber may be formed from ultra-high-molecular-weight polyolefins. Examples of such ultra-high-molecular-weight polyolefins include crystalline homopolymers or copolymers of ethylene, propylene, 1-butene, 4-methyl-1-pentene, 1-hexene, etc. Particularly useful among them may be ultra-high-molecular-weight polyethylene.

As used herein, the term “ultra-high-molecular-weight polyethylene” refers to ethylene homopolymer and any copolymer of ethylene with other copolymerizable monomers such as α-olefins (e.g., propylene, butylene, pentene, hexene, 4-methylpentene, octene) and acrylic esters (e.g., esters of acrylic acid, methacrylic acid, chloroacrylic acid). Also included is a blend of ethylene homopolymer and any copolymer of this type. The viscosity-average molecular weight thereof is usually at least 500,000, preferably at least 1,000,000, and more preferably at least 1,500,000. Smaller molecular weights may be disadvantageous for the development of high-strength.

Methods for making high-strength fibers are within the purview of those skilled in the art. Some examples include, but are not meant to be limited to, extruding processes, molding processes, wet-spinning processes, gel-spinning processes and the like. As described herein, the high-strength fibers may be colored following formation without significantly affecting the fibers strength. In addition, the fibers may be further processed to form braids, yarns and the like and in alternative embodiments, to be calandered or further processed to improve the porosity and/or the surface area of the fiber.

The present disclosure describes a process for producing colored high-strength fibers. The colored high-strength fibers may be produced, while maintaining sufficiently high tensile strength and high tensile modulus, from ultra-high-molecular-weight polyolefins by pretreating at least a portion of the high-strength fiber with at least one etching agent, prior to applying a dye to the etched fiber.

Any portion of the high-strength fiber may be pretreated by the etching agent. Pretreatment of the high-strength fiber with at least one etching agent may increase the surface area or roughness of the fiber. In addition, the hydrophilicity of the fiber may also be increased by the etching agent.

The etching agent may include any suitable alkaline substance or acidic substance. Many different alkaline and acidic agents, as well as salts thereof, may be employed in forming the colored high strength fibers described herein. The etching agents may be non-toxic and suitable for combination with biocompatible polymers. By way of example, suitable etching agents that may be used in the processes of coloring the fibers include sodium hypochlorite, calcium hydroxyapatite, sodium carbonate, sodium bicarbonate, potassium carbonate, potassium bicarbonate, magnesium carbonate, calcium carbonate, barium carbonate, potassium phosphate, sodium phosphate, magnesium oxide, magnesium hydroxide, sodium hydroxide, potassium hydroxide, barium hydroxide, cesium hydroxide, strontium hydroxide, calcium hydroxide, lithium hydroxide, rubidium hydroxide, neutral amines, trisodium phosphate, disodium hydrogen phosphate, sodium oxylate, sodium succinate, sodium citrate, sodium salicylate and/or salts of these substances. In addition, any combination of these and other alkaline substances or their salts may be used. In some particular embodiments, the alkaline agent may be selected from sodium hydroxide, potassium hydroxide and sodium hypochlorite.

The etching agent may be applied to the fiber as a solid, liquid or combination thereof. In certain embodiments, the etching agent may be combined with a suitable solvent to form an etching solution. The term solution is intended to include solutions, as well as suspensions, emulsions, dispersions, and the like. Some examples of suitable solvents for the etching agent include, but are not meant to be limited to, pentane, cyclopentane, hexane, cyclohexane, benzene, toluene, xylene, mesitylene, 1,4-dioxane, chloroform, diethyl ether, dichloromethane, tetrahydrofuran, 1,1,2-trichloroethane, trifluoroethanol, methyl acetate, ethyl acetate, amyl acetate, acetone, dimethylformamide, acetonitrile, dimethylsulfoxide, formic acid, n-butanol, isopropanol, ethanol, n-propronal, methanol, acetic acid, water, methylene chloride, cyclohexanone, ethyl formate, 2,2,2-trifluoroethanol, 2,2,3,3-tetrafluoro-1-propanol, 1,3-difluoro-2-propanol, 1,1,1,3,3,3-hexafluoro-2-methyl-2-propanol, 1,1,1,3,3,3-hexafluoro-2-propanol, 2,2,3,3,3-pentafluoro-1-propanol, nitroethane and combinations thereof.

In embodiments, the concentration of the etching agent may represent from about 0.01M to about 10M of the solution; in embodiments from about 0.05 M to about 0.1M.

The etching agent may be remain in contact with the fiber for a sufficient amount of time suitable for enhancing the high-strength fibers ability to interact with the at least one dye. Such a sufficient amount of time may vary depending upon the specific etching agent, the concentration of the etching agent and/or the specific material the high-strength fiber is made from.

In some embodiments, the etching agent may be in contact with the high-strength fiber from about 1 second to about 24 hours. In other embodiments, the etching agent may remain in contact with the fiber from about 5 minutes to about 5 hours.

It is envisioned that the etching agent may be applied to the fiber using any suitable method including dipping, spraying, wiping, painting, brushing, bathing, and the like. In certain embodiments, the etching agent may be applied to a portion of the fiber under ambient conditions, however it is envisioned that in some embodiments, the conditions surrounding the fiber may be altered to further enhance the etching agents ability to interact with the high-strength fiber. For example, the addition of heat, pressure, agitation and/or vacuum may be applied to the fiber or the etching agent prior to, during or after contact with the etching agent.

In some embodiments, the etched high-strength fiber may be rinsed with a rinsing agent to remove a majority of the etching agent prior to the application of the at least one dye. The process of rinsing may occur only once or may be repeated as necessary to remove the etching agent from the surface of the fiber. Suitable rinsing agents may include alcohols, saline, dextrose, and any variety of water, such as deionized water, sterile water, bacteriostatic water, distilled water, salt water, fresh water, and the like. In particularly useful embodiments, the rinsing agent may be deionized water.

It is envisioned that the rinsing agent may be applied to the etched fiber using any suitable method including dipping, spraying, wiping, painting, brushing, bathing, and the like. In certain embodiments, the rinsing agent may be applied to only the etched portions of the fiber however it is envisioned that the rinsing agent may also be applied to non-etched portions of the fiber as well. In addition, the rinsing agent may be applied to the etched fiber under ambient conditions, or in some embodiments, the conditions surrounding the etched fiber may be altered to further enhance the rinsing agents ability to remove the etching agent from the surface of the high-strength fiber. For example, the addition of heat, pressure, agitation and/or vacuum may be applied to the fiber or rinsing agent prior to, during and/or after application of the rinsing agent.

In some embodiments, the rinsed high-strength fiber may be dried prior to the application of the dye material to further enhance the fibers hydrophilicity and/or surface roughness. Drying may occur under room temperature or may be performed under conditions which will shorten the drying period. For example, the rinsed fibers may be positioned within an oven wherein the temperature may be altered to change the drying time of the fiber. The temperature of the oven may range from about 25° C. to about 110° C. In another example, the pressure surrounding the rinsed fiber may be increased or decreased to alter the drying time of the rinsed high-strength fiber. The pressure may range from about 0 Torr to about 760 Torr.

Following the pretreatment of the fiber with an etching agent, at least one dye may be applied to the high-strength fiber. In embodiments, the dye may be applied to the fiber after the fiber has been rinsed and/or dried. The dye may be applied to the fiber as a solid, liquid or combination thereof. In certain embodiments, the dye may be combined with a suitable solvent to form a dye solution. The term solution is intended to include solutions, as well as suspensions, emulsions, dispersions, and the like. Any variety of solvents may be suitable for forming the dye solution. Examples of suitable solvents include but are not limited to at least one of the following: pentane, cyclopentane, hexane, cyclohexane, benzene, toluene, xylene, mesitylene, 1,4-dioxane, chloroform, diethyl ether, dichloromethane, tetrahydrofuran, 1,1,2-trichloroethane, trifluoroethanol, methyl acetate, ethyl acetate, amyl acetate, acetone, dimethylformamide, acetonitrile, dimethylsulfoxide, formic acid, n-butanol, isopropanol, ethanol, n-propronal, methanol, acetic acid, water, methylene chloride, cyclohexanone, ethyl formate, 2,2,2-trifluoroethanol, 2,2,3,3-tetrafluoro-1-propanol, 1,3-difluoro-2-propanol, 1,1,1,3,3,3-hexafluoro-2-methyl-2-propanol, 1,1,1,3,3,3-hexafluoro-2-propanol, 2,2,3,3,3-pentafluoro-1-propanol, nitroethane and combinations thereof.

In embodiments, the concentration of the dye may represent from about 0.1% by weight to about 20% by weight of the solution; in embodiments from about 2% by weight to about 10% by weight.

The dye may remain in contact with the fiber for a sufficient amount of time suitable for enhancing the coloring of the high-strength fiber and may vary depending upon the specific dye, the concentration of the dye and/or the specific material the high-strength fiber is made from.

In some embodiments, the dye may be in contact with the high-strength fiber from about 0.1 seconds to about 24 hours. In other embodiments, the dye may remain in contact with the fiber from about 15 minutes to about 30 minutes.

It is envisioned that the dye may be applied to the fiber using any suitable method including dipping, spraying, wiping, painting, brushing, bathing, and the like. In certain embodiments, the dye may be applied to a portion of the fiber under ambient conditions, however it is envisioned that in some embodiments, the conditions surrounding the fiber may be altered to further enhance the dyes ability to interact with the high-strength fiber. For example, the addition of heat, pressure, agitation and/or vacuum may be applied to the fiber or the dye prior to, during or after contact with the dye. In certain embodiments, the high-strength fiber may be positioned within a dye solution wherein at least one of the fiber and the solution are agitated to further enhance the interaction between the fiber and the dye.

Although any suitable dye may be used in coloring the high-strength fibers, some non-limiting examples of suitable dyes include Chromium-cobalt-aluminum oxide (SICOPAL® BLUE K 6310 BASF), NYLANTHRENE® RED B-2BSA (manufactured by Crompton and Knowles Corp), CARALAN NAVYS BLL ACID BLUE 284 (manufactured by Carolina Color and Chemical Company), INTRASIL® BLUE BGL-N (manufactured by Crompton and Knowles Corp.), Ferric ammonium citrate, Pyrogallol, Logwood extract, D&C Blue No. 9, D&C Green No. 5, [Phthalocyaninato(2-)] copper, FD&C Blue No. 2, D&C Blue No. 6, D&C Green No. 6, D&C Red No. 17, D&C Violet No. 2 and combinations thereof.

The colored high-strength fibers may be used to form any variety of implantable medical devices. For instance, the fiber may be used to form a single or multifilament device. In some embodiments, the colored fibers may be used to form implantable medical devices selected from the group consisting of sutures, staples, meshes, grafts, occlusion devices, suture anchors and pledgets.

Colored high-strength fibers may be used to form multifilament devices suitable for use in laparoscopic, arthroscopic and even open surgical procedures. Because the multifilament high-strength fibers may be colored as described herein, the need for the addition of colored non-high strength fibers in a multifilament device may no longer be needed thereby maintaining the high-strength of the multifilament device.

The fibers described herein may be colored in any configuration. For example, in embodiments, the fibers may include only one color throughout the length of the fiber, while in other embodiments, the fibers may include a striped pattern of one or more colors over at least a portion of the length of the fiber. For instance, the colored fibers described herein may include 2 dyes in alternating formation to create stripes or a “candy-cane” effect on the fiber. In still other embodiments, any portion of the fiber may be colored with one dye, while the remaining portion of the fiber may be colored with a second dye. Devices including multiple different colors may be useful for identifying different ends of the fibers during surgery or the tying of a suture knot. In some embodiments, the dye may be applied to the fiber in any pattern, such as stripes, dots, letters, numbers, words and the like.

### Example 1

A fiber formed of ultra-high-molecular-weight polyethylene size 2/0 was dipped in a low concentration sodium hydroxide solution. The fiber was then washed with deionized water and dried under vacuum at room temperature. The dried fiber was then immersed in a constantly agitated dye suspension including SICOPAL® BLUE K 6310 BASF (Chromium-Cobalt-Aluminum Oxide) in methanol, a polar solvent with very low surface tension.

Those skilled in the art reading this disclosure will readily envision other uses for the colored high-strength fibers described herein.

It will be understood that various modifications may be made to the embodiments disclosed herein. Therefore, the above description should not be construed as limiting, but merely as exemplifications within the scope and spirit of the claims appended hereto.

What is claimed is:

1. A method of dyeing a high-strength fiber comprising the steps of:
contacting at least a portion of a fiber with an etching agent; and
applying at least one dye to the etched fiber.

2. The method of claim 1 wherein the high-strength fiber comprises an ultra-high-molecular-weight polyolefin.

3. The method of claim 1 wherein the high-strength fiber comprises ultra-high-molecular-weight polyethylene.

4. The method of claim 1 wherein contacting at least a portion of the fiber is selected from the group consisting of dipping, rolling, bathing, spraying, swabbing, wiping, painting, brushing, and combinations thereof.

5. The method of claim 1 wherein the etching agent comprises an agent selected from the group consisting of sodium hydroxide, sodium hypochlorite, potassium hydroxide, and combinations thereof.

6. The method of claim 1 wherein the etching agent comprises sodium hydroxide.

7. The method of claim 1 wherein the at least one dye comprises a dye selected from the group consisting of Chromium-cobalt-aluminum oxide, NYLANTHRENE® RED B-2BSA, CARALAN NAVYS BLL ACID BLUE 284, INTRASIL® BLUE BGL-N, Ferric ammonium citrate, Pyrogallol, Logwood extract, D&C Blue No. 9, D&C Green No. 5, [Phthalocyaninato(2-)] copper, FD&C Blue No. 2, D&C Blue No. 6, D&C Green No. 6, D&C Red No. 17, D&C Violet No. 2 and combinations thereof.

8. The method of claim 1 wherein the at least one dye comprises a biocompatible blue pigment made of Chromium-Cobalt-Aluminum Oxide.

9. The method of claim 1 further comprising the step of rinsing the etched fiber prior to applying the at least one dye to the etched fiber.

10. The method of claim 9 further comprising the step of drying the rinsed fiber prior to applying the at least one dye to the etched fiber.

11. A method of dyeing an ultra-high-molecular-weight polyethylene fiber comprising the steps of:
contacting at least a portion of a fiber with an etching solution
rinsing the fiber with a rinsing agent;
drying the rinsed fiber,
applying a dye solution to the dried fiber.

12. The method of claim 11 wherein contacting at least a portion of the fiber is selected from the group consisting of dipping, rolling, bathing, spraying, swabbing, wiping, painting, brushing, and combinations thereof.

13. The method of claim 11 wherein the etching solution comprises at least one etching agent selected from the group consisting of sodium hydroxide, sodium hypochlorite, potassium hydroxide, and combinations thereof.

14. The method of claim 13 wherein the etching agent comprises sodium hydroxide.

15. The method of claim 11 wherein the etching solution comprises a solvent selected from the group consisting of pentane, cyclopentane, hexane, cyclohexane, benzene, toluene, xylene, mesitylene, 1,4-dioxane, chloroform, diethyl ether, dichloromethane, tetrahydrofuran, 1,1,2-trichloroethane, trifluoroethanol, methyl acetate, ethyl acetate, amyl acetate, acetone, dimethylformamide, acetonitrile, dimethylsulfoxide, formic acid, n-butanol, isopropanol, ethanol, n-propronal, methanol, acetic acid, water, methylene chloride, cyclohexanone, ethyl formate, 2,2,2-trifluoroethanol, 2,2,3,3-tetrafluoro-1-propanol, 1,3-difluoro-2-propanol, 1,1,1,3,3,3-hexafluoro-2-methyl-2-propanol, 1,1,1,3,3,3-hexafluoro-2-propanol, 2,2,3,3,3-pentafluoro-1-propanol, nitroethane and combinations thereof.

16. The method of claim 11 wherein the dye solution comprises at least one dye.

17. The method of claim 11 wherein the dye solution comprises a solvent selected from the group consisting of pentane, cyclopentane, hexane, cyclohexane, benzene, toluene, xylene, mesitylene, 1,4-dioxane, chloroform, diethyl ether, dichloromethane, tetrahydrofuran, 1,1,2-trichloroethane, trifluoroethanol, methyl acetate, ethyl acetate, amyl acetate, acetone, dimethylformamide, acetonitrile, dimethylsulfoxide, formic acid, n-butanol, isopropanol, ethanol, n-propronal, methanol, acetic acid, water, methylene chloride, cyclohexanone, ethyl formate, 2,2,2-trifluoroethanol, tetrafluoro-1-propanol, 1,3-difluoro-2-propanol, 1,1,1,3,3,3-hexafluoro-2-methyl-2-propanol, 1,1,1,3,3,3-hexafluoro-2-propanol, 2,2,3,3,3-pentafluoro-1-propanol, nitroethane and combinations thereof.

18. The method of claim 16 wherein the at least one dye comprises a dye selected from the group consisting of Chromium-cobalt-aluminum oxide, NYLANTHRENE® RED B-2BSA, CARALAN NAVYS BLL ACID BLUE 284, INTRASIL® BLUE BGL-N, Ferric ammonium citrate, Pyrogallol, Logwood extract, D&C Blue No. 9, D&C Green No. 5, [Phthalocyaninato(2-)] copper, FD&C Blue No. 2, D&C Blue No. 6, D&C Green No. 6, D&C Red No. 17, D&C Violet No. 2 and combinations thereof.

19. The method of claim 16 wherein the at least one dye comprises a biocompatible blue pigment made of Chromium-Cobalt-Aluminum Oxide.

20. The method of claim 11 wherein the rinsing agent is selected from the group consisting of alcohols, saline, dextrose, deionized water, sterile water, bacteriostatic water, distilled water, salt water, fresh water, and combinations thereof.

21. The method of claim 11 wherein the rinsing agent comprises deionized water.

22. The method of claim 11 wherein the step of drying the rinsed fiber comprises applying heat to the rinsed fiber.

23. The method of claim 11 wherein the step of applying a dye solution to the fiber further comprises agitating the dye solution.

24. A colored high-strength fiber obtained from the method of claim 1.
